(19) United States
(12) Patent Application Publication
(10) Pub. No.: US 2008/0118813 A1
(43) Pub. Date: May 22, 2008

(54) FUEL CELL STRUCTURE AND FUEL CELL DEVICE INCLUDING THE SAME

(75) Inventors: Akira Kawakami, Kitakyushu-shi (JP); Naoki Watanabe, Kitakyushu-shi (JP)

Correspondence Address: BROOKS KUSHMAN P.C., 1000 TOWN CENTER, TWENTY-SECOND FLOOR, SOUTHFIELD, MI, 48075, US

(73) Assignee: TOTO LTD., Fukuoka (JP)

(21) Appl. No.: 11/855,592

(22) Filed: Sep. 14, 2007

(30) Foreign Application Priority Data
Sep. 15, 2006 (JP) 2006-251529

(51) Int. Cl. H01M 8/02; H01M 2/08; H01M 8/10

(52) U.S. Cl. 429/38; 429/31; 429/35

(57) ABSTRACT

The present invention relates to a fuel cell structure incorporated in a fuel cell device and a fuel cell device including such a fuel cell structure. The fuel cell structure (4) according to the present invention incorporated in a fuel cell device comprises a tubular fuel cell (6) and a support plate (12) through which an end (6a) of the fuel cell extends and to which it is fixed. The fuel cell (6) has an inner electrode layer (16), an outer electrode layer (20), and an electrolyte layer (18) disposed therebetween. The fuel cell (6) also has, on an outer peripheral surface at the one end (6a) thereof, an inner electrode exposed periphery (16a) where the inner electrode layer (16) is exposed. The one end (61) of the fuel cell (6) and the support plate (12) are sealingly fixed to each other with a conductive sealer (32). The sealer (32) extends onto the inner electrode exposed periphery (16a) and is spaced from the outer electrode layer (20).

### FIELD OF THE INVENTION

The present invention relates to a fuel cell structure used in a solid-oxide fuel cell (SOFC) and a fuel cell device including such a fuel cell structure, and more specifically, to a fuel cell structure having a tubular fuel cell and a fuel cell device including such a fuel cell structure.

### BACKGROUND OF THE INVENTION

Conventionally, a fuel cell device having a tubular fuel cell has been known as shown in, for example, FIGS. 1 and 6 in Japanese Patent Laid-open Publication No. 5-101842. Now, referring to FIG. 11, an example of a conventional fuel cell device will be explained. FIG. 11 is a schematically plan view of a conventional fuel cell device.

As shown in FIG. 11, a fuel cell device 100 has a case 102, five hollow hexagonal fuel cells 104 disposed therein, and two support plates 106, 108 for fixing the fuel cells 104 extending therethrough. Each of the fuel cells 104 has a hollow hexagonal inner electrode layer 110, a hollow hexagonal outer electrode layer 114, and a tubular electrolyte layer 112 disposed between these electrode layers 110, 114. The support plates 106, 108 are sealingly attached to the case 102 and interfaces between the support plates 106, 108 and the fuel cells 104 are sealed with a sealer 116, and thus, the case 2 is divided into first and second chambers 118, 120 through which gas acting on the inner electrode layer 110 flows, and a third chamber 122 through which gas acting on the outer electrode layer 114 flows. The first chamber 118 has a gas input port 124a, and the second chamber 120 has a gas output port 124b. The third chamber 122 has a gas input port 126a and a gas output port 126b. Further, in the first chamber 118, the inner electrode layer 110 has an inner electrode peripheral surface 110a exposed to an outer peripheral surface of the fuel cell 104, and an inner electrode connecting member 128 for taking out electricity from the inner electrode layer 110 is attached to the inner electrode peripheral surface 110a. Further, an outer electrode connecting member 130 for taking out electricity from the outer electrode layer 114 is attached thereto.

Gas acting on the inner electrode layer 110 enters the first chamber 118 through the input port 124a thereof, then enters the second chamber 120 through the tubular fuel cells 104 and then exits the second chamber 120 through the output port thereof. Further, gas acting on the outer electrode layer 114 enters the third chamber 122 through the input port 126a thereof and exits the same through the output port 126b thereof. Thus, the fuel cell device 1 is activated. Electricity at the inner electrode layer 110 is taken out through the inner electrode connecting member 128, while electricity at the outer electrode layer 114 is taken out through the outer electrode connecting member 130.

The fuel cell device 1 is manufactured, for example, as follows. First, the tubular fuel cells 104 are formed. At one end of each of the fuel cells 104, the inner electrode layer 110 is exposed to the outer peripheral surface of the fuel cell 104. The one end of each of the fuel cells 104 is passed through the first support plate 106, and the fuel cells 104 and the first support plate 106 are sealingly fixed to each other with the sealer 116. The inner electrode connecting member 128 is attached to the exposed inner electrode layer 110, while the outer electrode connecting member 130 is attached to the outer electrode layer 114. Then, the other end of each of the fuel cells 104 is passed through the second support plate 108, and the fuel cells 104 and the second support plate 108 are sealingly fixed to each other with the sealer 116.

As explained above, manufacturing such a conventional fuel cell device needs steps of sealingly fixing the fuel cells 104 to the first support plate 106, attaching the inner electrode connecting member 128 to the inner electrode layer 110, attaching the outer electrode connecting member 130 to the outer electrode layer 114, and sealingly fixing the fuel cells 104 to the second support plate 108. Thus, manufacturing such a fuel cell device 1 is complicated and difficult.

It is therefore an object of the present invention is to provide a fuel cell structure and a fuel cell device, manufacture of which becomes easy.

### SUMMARY OF THE INVENTION

In order to achieve the above-stated object, a fuel cell structure according to the present invention incorporated in a fuel cell device comprises at least one tubular fuel cell having a tubular outer electrode layer, a tubular inner electrode layer and a tubular electrolyte layer disposed between the inner and outer electrode layers, the fuel cell having, at one end thereof, an inner electrode exposed periphery where the inner electrode layer is exposed out of the electrolyte layer and the outer electrode layer; and an electrolyte exposed periphery adjacent to the inner electrode exposed periphery where the electrolyte layer is exposed out of the outer electrode layer; and a divisional portion attached to the one end of the fuel cell and dividing a region for gas acting on the inner electrode layer from a region for gas acting on the outer electrode layer; wherein the fuel cell has, on a peripheral surface at the one end thereof, an inner electrode peripheral surface electrically communicating with the inner electrode layer via the inner electrode exposed periphery; and wherein the one end of the fuel cell and the divisional portion are sealingly fixed to each other with a conductive sealer which extends on the inner electrode peripheral surface and is spaced from the outer electrode layer.

In this fuel cell structure according to the present invention, the fuel cell is in a form of tube, gas acting on the inner electrode layer flows through the tube of the fuel cell, and gas acting on the outer electrode layer flows therearound. At the one end of the fuel cell, gas sealing between a region for gas acting on the inner electrode and a region for gas acting on the outer electrode is achieved by means of the sealer and the divisional portion disposed at the one end of the fuel cell. Electricity generated at the inner electrode can be taken out through the inner electrode peripheral surface and the conductive sealer.

In this fuel cell structure according to the present invention, since electricity is taken out from the inner electrode layer through the inner electrode peripheral surface which is an outer peripheral surface of the fuel cell, and the conductive sealer is employed, the sealer has a gas-sealing function and a function of taking out electricity from the inner electrode. Thus, comparing with a conventional fuel cell structure in which the above-stated-functions are achieved by means of respective different components, the fuel cell structure according to the present invention is simple and manufacture thereof becomes easy.

Further, since the conductive sealer extends on the inner electrode peripheral surface and is spaced from the outer electrode layer, an electrical short circuit between the inner electrode and the outer electrode can be securely prevented. Further, since the conductive sealer has a good adhesion relative to the inner electrode peripheral surface, interface contact resistance becomes small and thus a fuel cell structure with good electrical power generating performance and good reliability can be easily manufactured.

In an embodiment of the fuel cell structure, preferably, the inner electrode peripheral surface is defined by the inner electrode exposed periphery, the sealer extends from the inner electrode exposed periphery to the electrolyte exposed periphery, and the electrolyte layer has a taper portion which becomes thin towards the inner electrode exposed periphery.

In this embodiment, when the fuel cell and the divisional portion are sealed to each other with the sealer, degradation of gas-sealing performance of the sealer due to bubbles and so on remaining between the inner electrode exposed periphery and the electrolyte exposed periphery can be prevented.

Further, in another embodiment of the fuel cell structure, preferably, the divisional portion has a support plate on one side of the fuel cell structure through which the one end of the fuel cell extends.

In this embodiment, manufacture of an integral fuel cell structure becomes easy by fixing a plurality of fuel cells to the support plate.

In this embodiment of the fuel cell structure, preferably, further comprises another support plate on the other side of the fuel cell structure through which the other end of the fuel cell or another fuel cell longitudinally coupled thereto and electrically connected thereto in a series; wherein the fuel cell or the other fuel cell has, on an outer peripheral surface at the other end thereof, an outer electrode peripheral surface electrically communicating with the outer electrode layer of the fuel cell or the other fuel cell; and wherein the other end of the fuel cell or the other fuel cell and the support plate on the other side of the fuel cell structure are sealingly fixed to each other with a conductive sealer which extends on the outer electrode peripheral surface.

In this embodiment, manufacture of the other end of the fuel cell or the other fuel cell becomes easy in addition to manufacture of the one end of the fuel cell.

In this embodiment of the fuel cell structure, the outer electrode peripheral surface may be defined by the outer electrode layer exposed to the outer peripheral surface of the fuel cell or the other fuel cell, or an outer electrode collecting layer disposed outside of the outer electrode layer of the fuel cell or the other fuel cell.

Further, in order to achieve the above-stated object, a fuel cell device according to the present invention comprises the above-stated fuel cell structure.

As explained above, the fuel cell structure and the fuel cell device according to the present invention allows manufacture thereof to become easy.

### BRIEF DESCRIPTION OF THE DRAWINGS

FIG. 1 is a schematically plan view of a fuel cell device according to a first embodiment of the present invention,

FIG. 2 is an enlarged cross-sectional view of one end of a fuel cell,

FIG. 3 is an enlarged cross-sectional view of the other end of the fuel cell,

FIG. 4 is a cross-sectional view of a first variant of the one end of the fuel cell,

FIG. 5 is a cross-sectional view of a second variant of the one end of the fuel cell,

FIG. 6 is a cross-sectional view of a first variant of the other end of the fuel cell,

FIG. 7 is a cross-sectional view of a second variant of the other end of the fuel cell,

FIG. 8 is a cross-sectional view of a third variant of the other end of the fuel cell,

FIG. 9 is a schematically plan view of a fuel cell device according to a second embodiment of the present invention,

FIG. 10 is a schematically plan view of a fuel cell device according to a third embodiment of the present invention, and

FIG. 11 is a schematically plan view of a fuel cell device in prior art.

### DETAILED DESCRIPTION OF THE PREFERRED EMBODIMENTS

Now, referring to Figures, embodiments of a fuel cell device according to the present invention will be explained in detail.

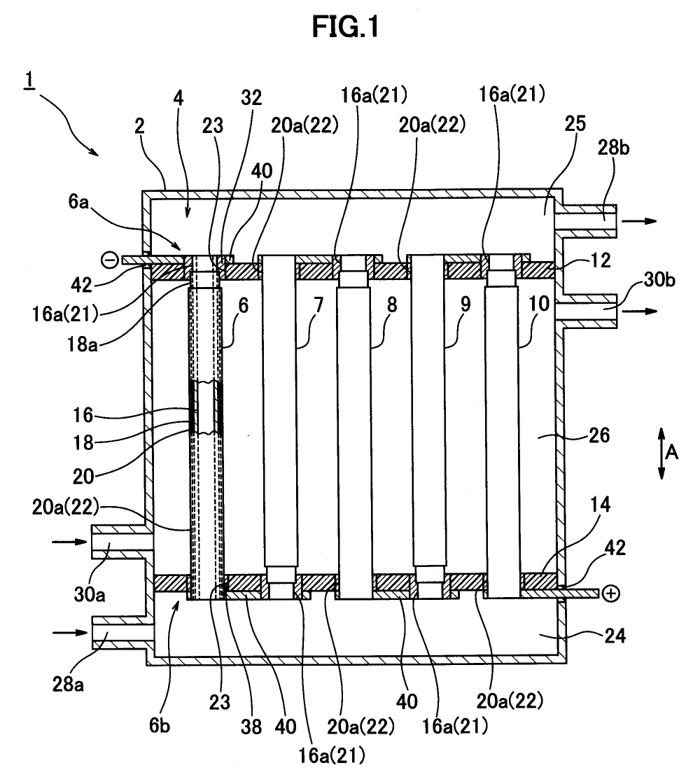

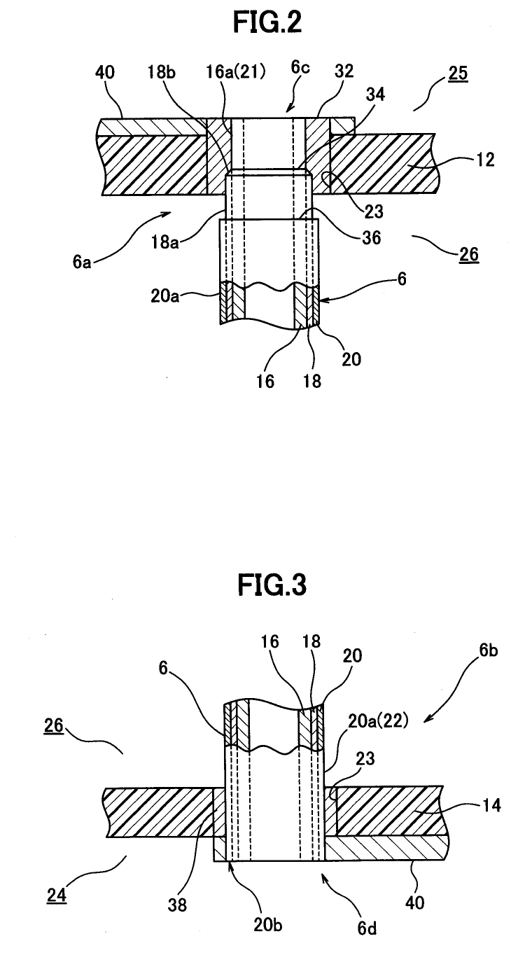

First, referring to FIGS. 1-3, a first embodiment of a fuel cell device according to the present invention will be explained. FIG. 1 is a schematically plan view of a fuel cell device according to the first embodiment of the present invention. FIG. 2 is an enlarged view of one end of a fuel cell and FIG. 3 is an enlarged view of the other end thereof.

As shown in FIG. 1, a fuel cell device 1 which is the first embodiment of the present invention has a case 2 and a fuel cell structure 4 according to the present invention disposed in the case 2.

The fuel cell structure 4 has five tubular fuel cells 6, 7, 8, 9, 10 having respective outer peripheral surface s and arranged laterally, and first and second support plates 12, 14 through which ends of the fuel cells extend and to which the ends thereof are fixed. In this embodiment, the fuel cells 6-10 are cylindrical. Hereinafter, the fuel cell 6 shown on the leftmost side in FIG. 1 is focused upon and will be explained.

The fuel cell 6 has a cylindrical inner electrode layer 16, a cylindrical outer electrode layer 20, and a cylindrical electrolyte layer 18 disposed between these electrode layers 16, 20. The fuel cell 6 has, at one end 6a thereof, an inner electrode exposed periphery 16a where the inner electrode layer 16 is exposed out of the electrolyte layer 18 and the outer electrode layer 20, and an electrolyte exposed periphery 18a where the electrolyte layer 18 is exposed out of the outer electrode layer 20, the inner electrode exposed periphery 16a and the electrolyte exposed periphery 18a defining portions of the outer peripheral surface of the fuel cell 6. The remaining portion of the outer peripheral surface of the fuel cell 6 including the other end 6b thereof is defined by an outer electrode exposed periphery 20a where the outer electrode layer 20 is exposed. In this embodiment, the inner electrode exposed periphery 16a also defines an inner electrode peripheral surface 21 electrically communicating with the inner electrode layer 16, and the outer electrode exposed periphery 20a also defines an outer electrode peripheral surface 22 electrically communicating with the outer electrode layer 20.

The inner electrode layer 16 is made of, for example, at least one of a mixture of Ni and zirconia doped with at least one of Ca and rare-earth elements such as Y and Sc; a mixture of Ni and ceria doped with at least one of rare-earth elements; and a mixture Ni and lanthanum-gallate doped with at least one of Sr, Mg, Co, Fe and Cu. The electrolyte layer 18 is made of, for example, at least one of zirconia doped with at least one of rare-earth elements such as Y and Sc; ceria doped with at least one of rare-earth elements; and lanthanum-gallate doped with at least one of Sr and Mg. The outer electrode layer 20 is made of, for example, at least one of lanthanum-manganite doped with at least one of Sr and Ca; lanthanum-ferrite doped with at least one of Sr, Co, Ni and Cu; samarium-cobalt doped with at least one of Sr, Fe, Ni and Cu; and silver. In this case, the inner electrode layer 16 is a fuel electrode, while the outer electrode layer 20 is an air electrode. A thickness of the inner electrode layer 16 is, for example, 1 mm, that of the electrolyte layer 18 is, for example, 30 μm, and that of the outer electrode layer 20 is, for example, 30 μm.

The first and second support plates 12, 14 are electric insulating, have respective apertures 22 through which the fuel cell 6 extends, and are sealingly attached to the case 2. Thus, the case 2 is divided into first and second chambers 24, 25 which are located on the respective opposite sides of the fuel cell 6 in a longitudinal direction A and through which gas acting on the inner electrode layer 16 flows, and a third chamber 26 which is located in the middle of the fuel cell 6 in the longitudinal direction A and though which gas acting on the outer electrode layer 20 flows. Namely, the support plates 12, 14 define divisional portions dividing a region for gas acting on the inner electrode layer 16 from a region for gas acting on the outer electrode layer 20. The first chamber 24 has a gas input port 28a and the second chamber 25 has a gas output port 28b. The third chamber 26 has a gas input port 30a and a gas output port 30b. The support plates 12, 14 are made of, for example, heat-resistant ceramics. Specifically, alumina, zirconia, spinel, forsterite, magnesia, or titania are preferably employed for such ceramics. The material of the support plates 12, 14 is more preferably one whose coefficient of thermal expansion is close to that of components defining a fuel cell stack. Further, gas acting on the inner electrode 16 is, for example, gas reformed from hydrogen or hydrocarbon fuel, while gas acting on the outer electrode 20 is, for example, air.

The one end 6a of the fuel cell 6 and the first support plate 12 are sealingly fixed to each other with a first conductive sealer 32.

As shown in FIG. 2, the inner electrode exposed periphery 16a and the electrolyte exposed periphery 18a extend over the entire circumference of the fuel cell 6 and are adjacent to each other in the longitudinal direction A. Further, the inner electrode exposed periphery 16a is located at a tip 6c of the fuel cell 6 and partially extends beyond the first support plate 12. A boundary 34 between the inner electrode exposed periphery 16a and the electrolyte exposed periphery 18a is located inside of the first support plate 12, while a boundary 36 between the electrolyte exposed periphery 18a and the outer electrode exposed periphery 20a is located in the third chamber 26. The first sealer 32 is disposed to divide a region for gas acting on the inner electrode layer 16, i.e., the second chamber 25, from a region for gas acting on the outer electrode layer 20, i.e., the third chamber 26.

The first sealer 32 extends from the inner electrode exposed periphery 16a to the electrode exposed periphery 18a over the entire circumference of the fuel cell 6, and is spaced from the outer electrode layer 20 via the electrolyte exposed periphery 18a. Further, the electrolyte exposed periphery 18a has a taper portion 18b which becomes thin toward the inner electrode exposed periphery 16a. The first sealer 32 is, for example, silver, a mixture of silver and glass, or wax including silver, gold, nickel, copper, titan and so on.

Further, the other end 6b of the fuel cell 6 and the second support plate 14 are sealingly fixed to each other with a second conductive sealer 38.

As shown in FIG. 3, the second sealer 38 is disposed to substantially divide a region for gas acting on the inner electrode layer 16, i.e., the first chamber 24, from a region for gas acting on the outer electrode layer 20, i.e., the third chamber 26. Specifically, only an end surface 20b of the outer electrode layer 20 is exposed to the first chamber 24.

The second sealer 38 extends on the outer electrode exposed periphery 20a. The outer electrode exposed periphery 20a partially extends beyond the second support plate 14. The second sealer 38 is, for example, silver, a mixture of silver or glass, and wax including silver, gold, nickel, copper, titan and so on.

Each of the other fuel cells 7-10 has a structure similar to that of the fuel cell 6. Hereinafter, components of the fuel cells 7-10 are explained in such a way that they are indicated by the same reference numbers as those indicating the corresponding components of the fuel cell 6

As shown in FIG. 1, the five fuel cells 6-10 are alternately arranged so that, regarding two adjacent fuel cells thereof, the inner electrode peripheral surface, namely, the inner electrode exposed periphery 16a at the one end 6a of the one fuel cell, is adjacent to the outer electrode peripheral surface, namely, the outer electrode exposed periphery 20a at the other end 6b of the other fuel cell. Thus, regarding the second and fourth fuel cells 7, 9, the one ends 6a thereof are fixed to the second support plate 14, while the other ends 6b thereof are fixed to the first support plate 12.

Connections 15 have connecting members 40 for electrically connecting the inner electrode exposed periphery 16a to the outer electrode exposed periphery 20a adjacent thereto, or for electrically connecting the inner electrode exposed periphery 16a or the outer electrode exposed periphery 20a to the exterior. In this embodiment, the connecting members 40 are disposed on a first-chamber 24 side of the second support plate 14 or on a second-chamber 25 side of the first support plate 12. Further, in this embodiment, the five fuel cells are electrically connected to each other in a series. The connecting members 40 respectively electrically connected to the inner electrode exposed periphery 16a of the fuel cell 6 and the outer electrode exposed periphery 20a of the fuel cell 10 extend through the case 2 to pick up electricity therefrom outside of the case. The case 2 is made of heat-resistant metal, for example, stainless steel, nickel base alloy and chrome base alloy, and an insulating member 42 is disposed between the case 2 and the connecting members 40. The connecting members 40 are made of heat-resistant metal such as stainless steel, nickel base alloy and chrome base alloy, or conductive ceramic material such as lanthanum chromite. In view of the simplification of manufacturing processes and cost reduction, the connecting members 40 are preferably conductive films which are pre-formed on the support plates 12, 14 and made of, for example, silver, nickel, copper and so on with a thickness within 1-500 μm.

Next, an operation of the fuel cell device according to the present invention will be explained.

Gas (fuel gas) acting on the inner electrode layer 16 enters the first chamber 24 through the input port 28a thereof, then enters the second chamber 25 through the tubular fuel cells 6-10 and exits the second chamber 25 through the output port 28b thereof. Further, gas (air) acting on the outer electrode layer 20 enters the third chamber through the input port 30a thereof and exits the same through the output port 30b thereof. Thus, the fuel cell device 1 is activated. Electricity from the inner electrodes 16 can be taken out via the first sealer 32 and the connecting member 40, while electricity from the outer electrodes 20 can be taken out via the second sealer 38 and the connecting member 40.

Since there is no member for taking out electricity from the outer electrode 20 inside of the third chamber 26, resistance against flow of gas acting on the outer electrode 20 can be reduced.

When the gas acting on the inner electrode layer 16 is fuel gas such as gas reformed from hydrogen or hydrocarbon fuel, disposing the connecting members 40 on the first-chamber 24 side of the second support plate 14 or the second-chamber 25 side of the first support plates 12 allows oxidation degradation of the connecting members 40 to be restricted.

Further, the sealers 32, 38 have a function of sealingly fixing the fuel cells 6-10 to the support plates 12, 14 and a function of taking out electricity from the inner electrode 16 and the outer electrode 20 of the fuel cell. Thus, a structure of the fuel cell structure 4 is simple.

Further, since electricity from the inner electrode 16 is taken out through the inner electrode exposed periphery 16a, flow of gas acting on the inner electrode 15 is not obstructed. Further, since a contact area between the sealer 32 and the inner electrode peripheral surface 16a can become larger, contact resistance therebetween can be reduced. Especially, it is advantageous to use fuel cells each having a diameter within 1-10 mm.

Next, an example of a way of manufacturing a fuel cell device according to the present invention will be explained.

First, tubular fuel cells are formed. Specifically, the tubular inner electrode layer 16 is formed, then, the electrolyte layer 18 is formed around the inner electrode layer 16 so that the end of the inner electrode layer 16 is exposed, and then the outer electrode layer 20 is formed around the electrolyte layer 18 so that the end of the electrolyte layer 18 is exposed. After that, the taper portion 18b may be formed at the end of the electrolyte layer 18.

Next, the conductive films defining the connecting members 40 are formed on the support plates 12, 14. In view of the simplification of manufacturing processes and cost reduction, the conductive film is preferably pre-formed on the support plates 12, 14 by a wet process, for example, a screen print process, slurry coating process or sheet adhering process.

Next, the fuel cells 6-10 are disposed in the predetermined directions, the ends of the fuel cells 6-10 are passed through the first and second plates 12, 14, and then the fuel cells 6-10 and the first and second support plates 12, 14 are sealingly fixed to each other with the first and second sealers 32, 38. At this point, the sealers 32, 38 are disposed so as to make sure to contact both the fuel cells 6-10 and the conductive film formed on the support plates 12, 14. Thus, a fuel cell stack including the fuel cell structure 4 according to the present invention is formed.

Next, the fuel cell stack is fixed inside the case 2 and thus the fuel cell device 1 is formed.

Since the inner electrode exposed periphery 16a is employed and the sealers 32, 38 are used, the manufacturing process of the fuel cell stack and the fuel cell device 1 becomes easy. Specially, it is advantageous to use the fuel cells 6-10 each having a diameter within 1-10 mm.

Further, when the sealer 32 is disposed or filled between the support plate 12 and the fuel cells 6-10, the taper portion 18b of the electrolyte layer 18 can prevent degradation of gas-sealing performance of the sealer 32 due to bubbles and so on remaining between the inner electrode exposed periphery 16a and the electrolyte exposed periphery 18a. This improves a yield ratio and easily allows a stable manufacturing process.

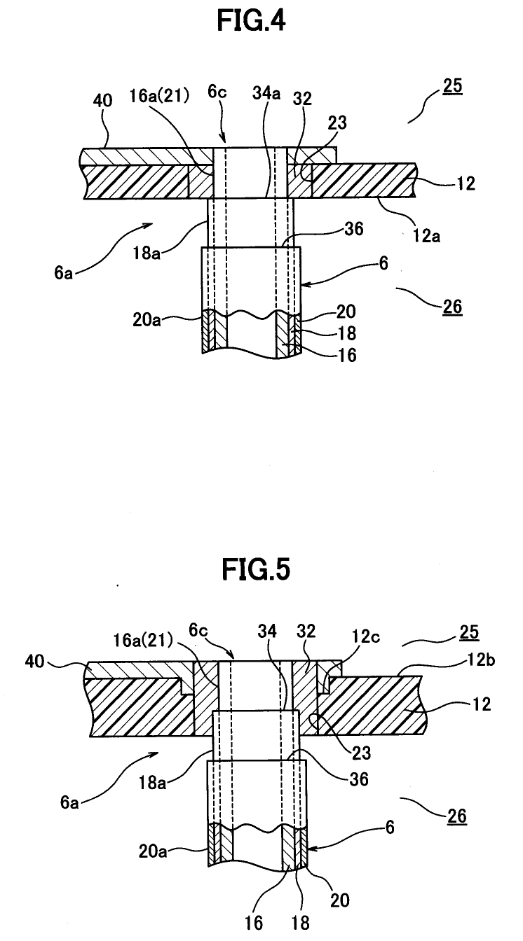

Next, referring to FIGS. 4 and 5, variants of the one end 6a of the fuel cell 6 will be explained.

FIG. 4 is a cross-sectional view of a first variant of the one end of the fuel cell. As shown in FIG. 4, the boundary 34a between the inner electrode exposed periphery 16a and the electrolyte exposed periphery 18a may be located in the same plane as that including a surface 12a of the first support plate 12 on the third-chamber 26 side thereof, and the sealer 32 is disposed only around the inner electrode exposed periphery 16a. Further, the connecting members 40 may be disposed so as to contact the inner electrode exposed periphery 16a.

FIG. 5 is a cross-sectional view of a second variant of the one end of the fuel cell. As shown in FIG. 5, a recess 12c may be provided on a surface 12b of the first support plate 12 on the second-chamber 25 side thereof so that a contact area between the connecting members 40 and the sealer 32 become large.

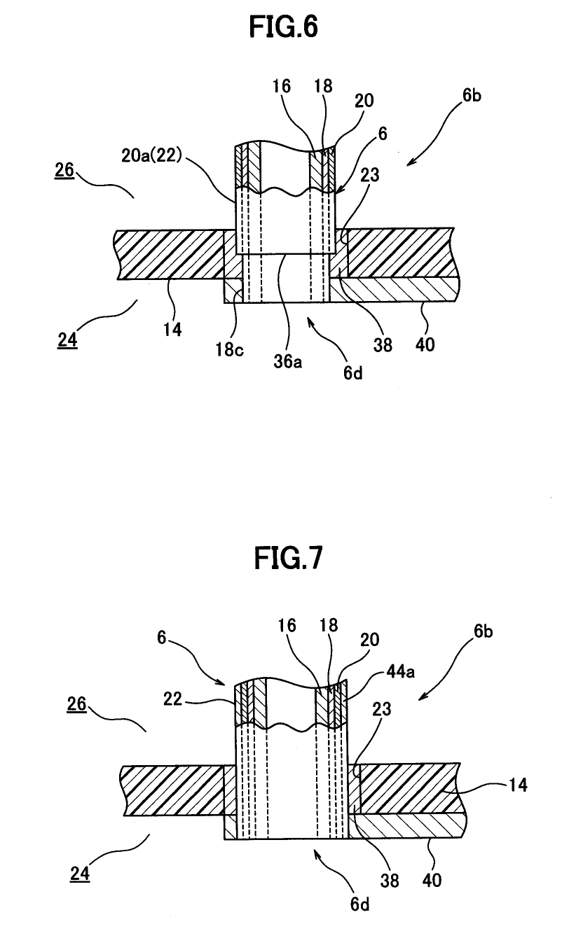

Next, referring to FIGS. 6-8, variants of the other end 6b of the fuel cell 6 will be explained.

FIG. 6 is a cross-sectional view of a first variant of the other end of the fuel cell. As shown in FIG. 6, at a tip 6d of the other end 6b of the fuel cell 6, the electrolyte layer 18 may be exposed to the outer peripheral surface of the fuel cell 6 to form a second electrolyte exposed periphery 18c, and a boundary 36a between the outer electrode exposed periphery 20a and the second electrolyte exposed the outer peripheral surface 18c may be located inside of the second support plate 14. Thus, a region for gas acting on the inner electrode layer 16, i.e., the first chamber 24, can be divided from a region for gas acting on the outer electrode layer 20, i.e. the third chamber 26.

Further, the outer electrode 20 can prevent from degradation caused by contacting gas acting on the inner electrode 16.

FIG. 7 is a cross-sectional view of a second variant of the other end of the fuel cell. As shown in FIG. 7, an outer electrode collecting layer 44a may be disposed entirely or partially around the outer electrode 20 of the fuel cell 6. In this variant, the outer electrode peripheral surface 22 electrically connected to the outer electrode 20 is defined by the outer electrode collecting layer 44a. The outer electrode collecting layer 44a is, for example, a porous conductive film containing silver. A thickness of the outer electrode collecting layer 44a is, for example, 10 μm. Further, the outer electrode collecting layer 44a may be formed of wire or mesh of silver or heat-resistant metal. The outer electrode collecting layer 44a serves as an electrical passage when the outer electrode layer 20 is thin so that it does not tend to conduct electricity.

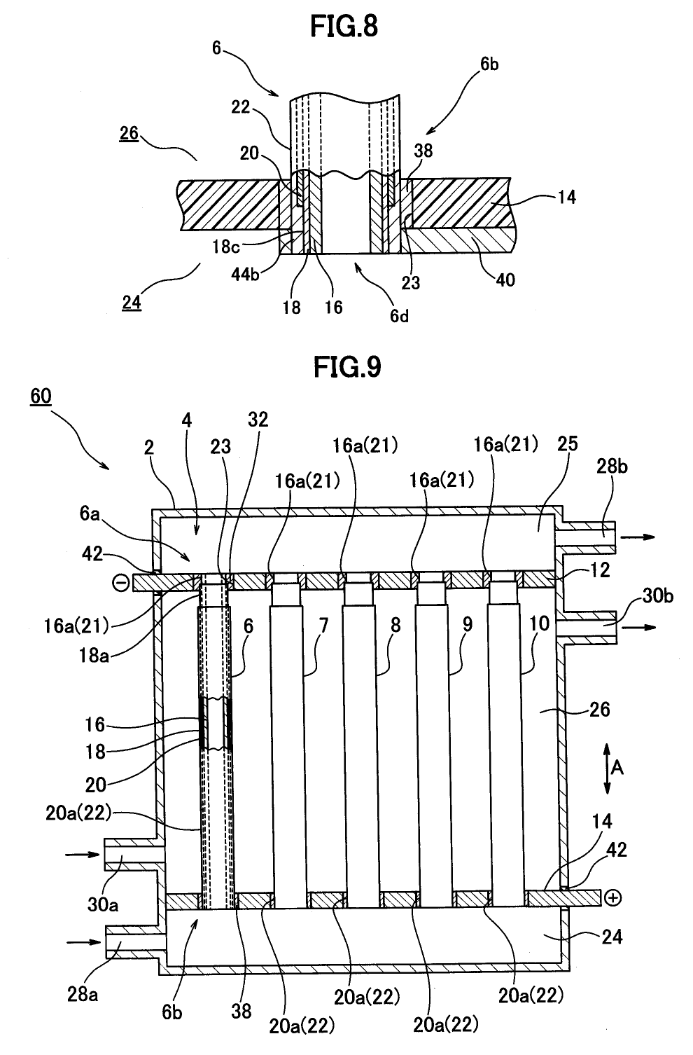

FIG. 8 is a cross-sectional view of a third variant of the other end of the fuel cell. As shown in FIG. 8, at the tip 6d of the other end 6b of the fuel cell 6, the electrolyte layer 18 may be exposed to the outer peripheral surface of the fuel cell 6 to form a second electrolyte exposed periphery 18b, and then an outer electrode collecting layer 44b may be disposed entirely or partially around the outer electrode 20 and the second electrolyte exposed periphery 18b. In this variant, the outer electrode peripheral surface 22 electrically connected to the outer electrode 20 is defined by the outer electrode collecting layer 44b. A material, a thickness and so on of the outer electrode collecting layer 44b are the same as those of the outer electrode collecting layer 44a of the above-stated second variant. The outer electrode collecting layer 44b can prevent degradation caused by contacting the outer electrode 20 to gas acting on the inner electrode 16.

Next, referring to FIG. 9, a second embodiment of the fuel cell device according to the present invention will be explained. FIG. 9 is a schematically plan view thereof.

As shown in FIG. 9, a fuel cell device 60 according to the second embodiment of the present invention has a structure similar to that of the fuel cell device 1 according to the first embodiment of the present invention except that the five fuel cells 6-10 are arranged in the same direction, the support plates 12, 14 is made of a conductive material and the connecting members are omitted. The fuel cells 6-10 of the fuel cell device 60 are electrically connected in parallel.

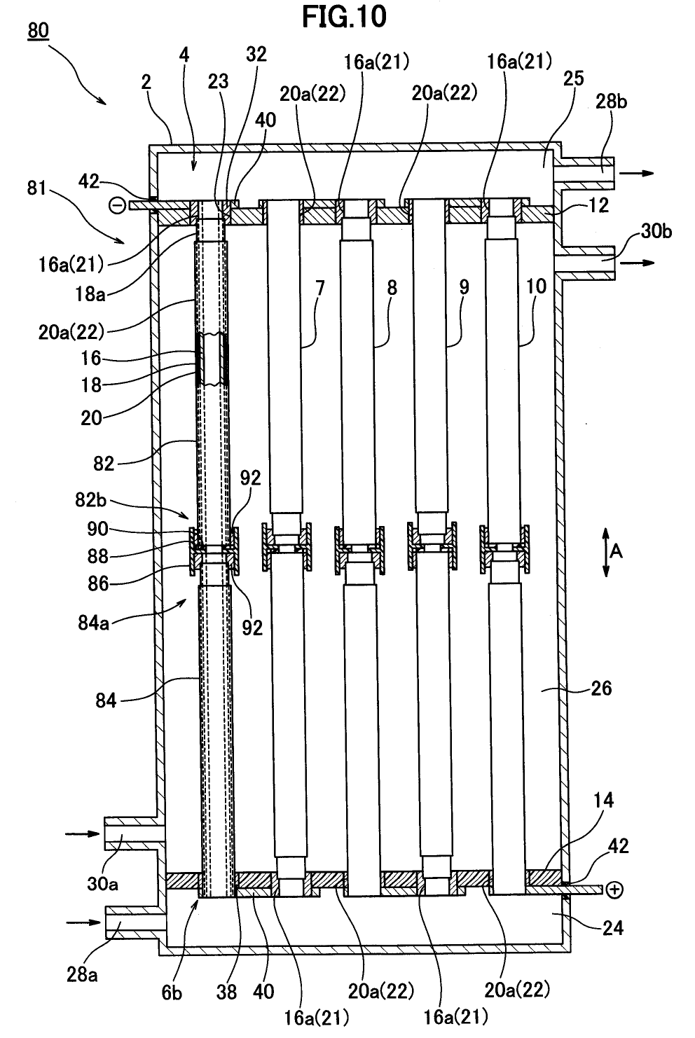

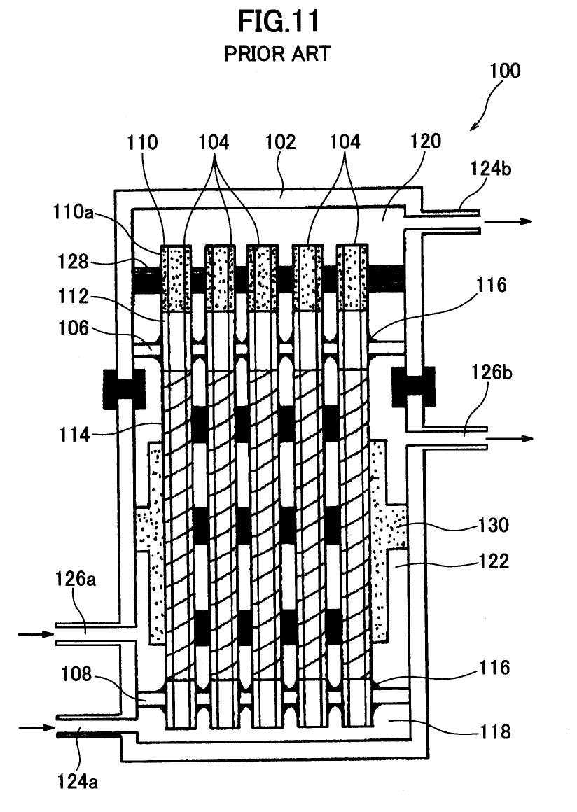

Next, referring to FIG. 10, a third embodiment of the fuel cell device according to the present invention will be explained. FIG. 10 is a schematically plan view thereof.

As shown in FIG. 10, a fuel cell device 80 which is the third embodiment of the present invention is obtained by replacing the five fuel cells 6-10 in the fuel cell device 1 according to the first embodiment of the present invention with five fuel cell bodies 81, in each of which two fuel cells are coupled in the longitudinal direction A and electrically connected in a series. Now, these fuel cell bodies 81 will be explained.

Each of the fuel cell bodies 81 has two fuel cells 82, 84 coupled to each other in the longitudinal direction A and electrically connected to each other in a series, and a coupling member 86 coupling one (referred to other later) end 82b of the fuel cell 82 and one end 84a of the fuel cell 84. Since each of the fuel cells 82, 84 has the same components as those in the fuel cell 6 in the fuel cell device 1 according to the first embodiment of the present invention, the components of the fuel cells 82, 84 are indicated by the same reference numbers as those of the components in the fuel cell 6 and explanations of the former components are omitted. It should be noted that the other end 82b of the fuel cell 82 corresponds to the other end 6b of the fuel cell 6 and the one end 84a of the fuel cell 84 corresponds to the one end 6a of the fuel cell 6.

The coupling member 86 is tubular and is disposed so that it encloses the other end 82b of the fuel cell 82 and the one end 84a of the fuel cell 84. The coupling member 86 has an annular protrusion 88 in the middle thereof in the longitudinal direction A. The other end 82b of the fuel cell 82 abuts to the protrusion 88 via an insulating body 90 and the one end 84a of the fuel cell 84 also abuts to the protrusion 88. The coupling member 86 is formed of a conductive material, and gaps between the fuel cells 82, 84 and the coupling member 86 are sealed with a conductive sealer 92 to make a passage for gas acting on the inner electrode layer 16. The coupling member 86 is made of, for example, heat-resistant metal such as stainless steel, nickel base alloy and chromium base alloy, or ceramics such as lanthanum chromite. The sealer 92 is formed of silver, a mixture of silver and glass, or wax material including silver, gold, nickel, copper, titanium and so on.

The embodiment of the present invention has been explained, but the present invention is not limited to the above-mentioned embodiment and it is apparent that the embodiment can be changed within the scope of the present invention set forth in the claims.

Although, in the above-stated embodiments, the inner electrode layer 16 defines a fuel electrode while the outer electrode layer 20 defines an air electrode, conversely, a fuel cell device may be formed so that the inner electrode layer 16 may be an air electrode while the outer electrode layer 20 may be a fuel electrode. In this case, if gas acting on the inner electrode layer 16 is oxidation gas such as air, the connecting members 40 may be disposed on the third-chamber 26 side of the support plates for restriction of oxidation degradation of the connecting members 40.

Although, in the above-stated embodiments, the inner electrode exposed periphery 16a and the electrolyte exposed periphery 18a completely extend therearound, they may not, as long as electricity can be taken out from the outer peripheral surface of the fuel cell.

The outer electrode peripheral surface 22 means an outer peripheral surface of the fuel cell 6 electrically communicating with the outer electrode 20 and thus it may be defined by the outer electrode 20 exposed to the outer peripheral surface of the fuel cell 6 like in the above-stated first embodiment of the fuel cell device, or the outer electrode collecting layer 44a, 44b exposed to the outer peripheral surface of the fuel cell 6 like in the above-stated variant of the other end of the fuel cell in the first embodiment of the fuel cell device, or other configuration.

Further, an inner electrode collecting layer similar to the outer electrode collecting layer may be provided entirely or partially around the inner electrode layer 16 of the fuel cell 6. For example, such an inner electrode collecting layer may be provided inside of the inner electrode layer 16 or outside of the inner electrode exposed periphery 16a. In the latter case, the inner electrode peripheral surface 21 electrically communicating with the inner electrode layer 16 is defined by the inner electrode collecting layer.

Further, the fuel cell body 81 in the above-stated third embodiment of the fuel cell device may have more than two fuel cells coupled to each other.

Further, in the above-stated first, second and third embodiments, although the divisional portions are explained as the support plates 12, 14, a configuration of the divisional application is arbitrary al long as a region for gas acting on the inner electrode layer 16 is divided from a region for gas acting on the outer electrode layer 20 and thus, for example, such a configuration is that of a cap covering the ends of the fuel cell 6.

Further, in the above-stated embodiments, the fuel cell is a cylindrical tube with a circular cross section, but it may be another cross-sectional form as long as it is tubular. Concretely, the fuel cell may be in a flat-tube form having an oblong or oval cross section or in a polyangular-tube form having a polyangular section.

Further, the above-stated embodiments and variants can appropriately be combined within the scope of the present invention.

What is claimed is:

1. A fuel cell structure incorporated in a fuel cell device comprising:
at least one tubular fuel cell having a tubular outer electrode layer, a tubular inner electrode layer and a tubular electrolyte layer disposed between the inner and outer electrode layers, the fuel cell having, at one end thereof, an inner electrode exposed periphery where the inner electrode layer is exposed out of the electrolyte layer and the outer electrode layer, and an electrolyte exposed periphery adjacent to the inner electrode exposed periphery where the electrolyte layer is exposed out of the outer electrode layer; and
a divisional portion attached to the one end of the fuel cell and dividing a region for gas acting on the inner electrode layer from a region for gas acting on the outer electrode layer;
wherein the fuel cell has, on an outer peripheral surface at the one end thereof, an inner electrode peripheral surface electrically communicating with the inner electrode layer via the inner electrode exposed periphery; and
wherein the one end of the fuel cell and the divisional portion are sealingly fixed to each other with a conductive sealer which extends onto the inner electrode peripheral surface and is spaced from the outer electrode layer.

2. The fuel cell structure according to claim 1, wherein the inner electrode peripheral surface is defined by the inner electrode exposed periphery, the sealer extends from the inner electrode exposed periphery to the electrolyte exposed periphery, and the electrolyte layer has a taper portion which becomes thin towards the inner electrode exposed periphery.

3. The fuel cell structure according to claim 1, wherein the divisional portion has a support plate on one side of the fuel cell structure through which the one end of the fuel cell extends.

4. The fuel cell structure according to claim 3, further comprising another support plate on the other side of the fuel cell structure through which the other end of the fuel cell or another fuel cell longitudinally coupled thereto and electrically connected thereto in a series,
wherein the fuel cell or the other fuel cell has, on an outer peripheral surface at the other end thereof, an outer electrode peripheral surface electrically communicating with the outer electrode layer of the fuel cell or the other fuel cell; and
wherein the other end of the fuel cell or the other fuel cell and the support plate on the other side of the fuel cell structure are sealingly fixed to each other with a conductive sealer which extends on the outer electrode peripheral surface.

5. The fuel cell structure according to claim 4, wherein the outer electrode peripheral surface is defined by the outer electrode layer exposed to the outer peripheral surface of the fuel cell or the other fuel cell.

6. The fuel cell structure according to claim 4, wherein the fuel cell or the other fuel cell further has an outer electrode collecting layer disposed outside of the outer electrode layer, and the outer electrode peripheral surface is defined by the outer electrode collecting layer.

7. A fuel cell device comprising the fuel cell structure according to claim 1.

8. The fuel cell structure according to claim 2, wherein the divisional portion has a support plate on one side of the fuel cell structure through which the one end of the fuel cell extends.

9. The fuel cell structure according to claim 8, further comprising another support plate on the other side of the fuel cell structure through which the other end of the fuel cell or another fuel cell longitudinally coupled thereto and electrically connected thereto in a series,
wherein the fuel cell or the other fuel cell has, on an outer peripheral surface at the other end thereof, an outer electrode peripheral surface electrically communicating with the outer electrode layer of the fuel cell or the other fuel cell; and
wherein the other end of the fuel cell or the other fuel cell and the support plate on the other side of the fuel cell structure are sealingly fixed to each other with a conductive sealer which extends on the outer electrode peripheral surface.

10. The fuel cell structure according to claim 9, wherein the outer electrode peripheral surface is defined by the outer electrode layer exposed to the outer peripheral surface of the fuel cell or the other fuel cell.

11. The fuel cell structure according to claim 9, wherein the fuel cell or the other fuel cell further has an outer electrode collecting layer disposed outside of the outer electrode layer thereof, and the outer electrode peripheral surface is defined by the outer electrode collecting layer.
